(19) United States
(12) Patent Application Publication
(10) Pub. No.: US 2011/0025590 A1
(43) Pub. Date: Feb. 3, 2011

(54) DISPLAY DEVICE HAVING BI-DIRECTIONAL SCAN MECHANISM AND GATE SIGNAL SCANNING METHOD THEREOF

(76) Inventors: Jian-Hong Lin, Hsin-Chu (TW); Wei-Cheng Lin, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 12/630,852

(22) Filed: Dec. 4, 2009

(30) Foreign Application Priority Data
Jul. 31, 2009 (TW) 098125876

(51) Int. Cl. G09G 3/36

(52) U.S. Cl. 345/100

(57) ABSTRACT

A display device having bi-directional scan mechanism includes a plurality of gate lines, a first shift register circuit and a second shift register circuit. The first shift register circuit includes a plurality of forward shift register stages. The second shift register circuit includes a plurality of backward shift register stages. Each of the gate lines is electrically connected to both a corresponding forward shift register stage and a corresponding backward shift register stage. When the first shift register circuit is enabled, the forward shift register stages are employed to provide plural forward gate signals sequentially enabled for scanning the gate lines based on a first sequence. When the second shift register circuit is enabled, the backward shift register stages are employed to provide plural backward gate signals sequentially enabled for scanning the gate lines based on a second sequence opposite to the first sequence.

### BACKGROUND OF THE INVENTION

1. Field of the Invention

The present invention relates to a display device and gate signal scanning method thereof, and more particularly, to a display device having bi-directional scan mechanism and gate signal scanning method thereof.

2. Description of the Prior Art

Along with the advantages of thin appearance, low power consumption, and low radiation, liquid crystal displays have been widely applied in various electronic products for panel displaying. The operation of a liquid crystal display is featured by varying voltage drops between opposite sides of a liquid crystal layer for twisting the angles of the liquid crystal molecules in the liquid crystal layer so that the transmittance of the liquid crystal layer can be controlled for illustrating images with the aid of the light source provided by a backlight module. In general, the liquid crystal display comprises plural pixel units, a shift register circuit, and a source driver. The source driver is utilized for providing plural data signals to be written into the pixel units. The shift register circuit is employed to generate plural gate signals furnished to the pixel units for providing a control of writing the data signals into the pixel units.

FIG. 1 is a schematic diagram showing a prior-art liquid crystal display. As shown in FIG. 1, the liquid crystal display 100 includes a pixel array 101 and a shift register circuit 110. The shift register circuit 110 comprises a plurality of shift register stages and, for ease of explanation, illustrates an (N−1)th shift register stage 111, an Nth shift register stage 112 and an (N+1)th shift register stage 113. The (N−1)th shift register stage 111 is enabled to generate a gate signal SGn−1 based on a gate signal SGn−2. The gate signal SGn−1 is used to provide a control of writing a corresponding data signal of a data line DLi into the pixel unit 103 of the pixel array 101. The gate signal SGn−1 is further used to enable the Nth shift register stage 112 for generating a gate signal SGn. Similarly, the gate signal SGn is used to control a writing operation regarding the pixel unit 104 of the pixel array 101 and to enable the (N+1)th shift register stage 113 for generating a gate signal SGn+1. Also, the gate signal SGn+1 is used to control a writing operation regarding the pixel unit 105 of the pixel array 101 and to enable a following shift register stage for generating a corresponding gate signal.

Regarding the operation of the shift register circuit 110, the plural shift register stages are put in use only for performing a unidirectional scanning process so as to drive the pixel units according to a default sequence. It is well known that liquid crystal displays have been widely integrated into various portable electronic products such as mobile phones, personal digital assistants (PDAs), and mini audio/video playbacks. However, due to different install layouts for internal circuit boards of different portable electronic products, the display scanning standards of embedded liquid crystal displays are also different. For that reason, the prior-art liquid crystal display with unidirectional scan mechanism cannot provide a high-compatible display scanning standard for existing diversified electronic products to accommodate, i.e. having a lack of high embedding flexibility.

### SUMMARY OF THE INVENTION

In accordance with an embodiment of the present invention, a display device having bi-directional scan mechanism is provided. The display device comprises a pixel array, a first shift register circuit and a second shift register circuit. The pixel array has a plurality of rows of pixel units and a plurality of parallel gate lines. The gate lines are perpendicular to a first direction and disposed sequentially along the first direction. Each of the gate lines is electrically connected to plural pixel units in a corresponding row of pixel units. The first shift register circuit has a plurality of forward shift register stages. The forward shift register stages are employed to provide plural forward gate signals sequentially enabled for scanning the gate lines so as to drive the rows of pixel units base on a sequence along the first direction when the first shift register circuit is enabled. The second shift register circuit has a plurality of backward shift register stages. The backward shift register stages are employed to provide plural backward gate signals sequentially enabled for scanning the gate lines so as to drive the rows of pixel units base on a sequence along a second direction opposite to the first direction when the second shift register circuit is enabled. Each of the gate lines is further electrically connected to both a corresponding forward shift register stage of the first shift register circuit and a corresponding backward shift register stage of the second shift register circuit.

The present invention further provides a gate signal scanning method for use in a display device. The display device comprises a pixel array, a first shift register circuit and a second shift register circuit. The pixel array has a plurality of rows of pixel units and a plurality of gate lines. The gate lines are perpendicular to a first direction and disposed sequentially along the first direction. Each of the gate lines is electrically connected to plural pixel units in a corresponding row of pixel units. The first shift register circuit is utilized for providing plural forward gate signals sequentially enabled for scanning the gate lines base on a sequence along the first direction. The second shift register circuit is utilized for providing plural backward gate signals sequentially enabled for scanning the gate lines base on a sequence along a second direction opposite to the first direction. The gate signal scanning method comprises powering the display device, detecting a pose status of the display device; enabling the first shift register circuit to output the forward gate signals for scanning the gate lines so as to drive the rows of pixel units based on a sequence along the first direction when the pose status of the display device is detected to be a first pose status, and enabling the second shift register circuit to output the backward gate signals for scanning the gate lines so as to drive the rows of pixel units based on a sequence along the second direction when the pose status of the display device is detected to be a second pose status.

Still, the present invention provides another gate signal scanning method for use in a display device. The display device comprises a pixel array, a first shift register circuit and a second shift register circuit. The pixel array has a plurality of rows of pixel units and a plurality of gate lines. The gate lines are perpendicular to a first direction and disposed sequentially along the first direction. Each of the gate lines is electrically connected to plural pixel units in a corresponding row of pixel units. The first shift register circuit is utilized for providing plural forward gate signals sequentially enabled for scanning the gate lines base on a sequence along the first direction. The second shift register circuit is utilized for providing plural backward gate signals sequentially enabled for scanning the gate lines base on a sequence along a second direction opposite to the first direction. The gate signal scanning method comprises powering the display device, setting a scanning mode of the display device according to an indication signal, enabling the first shift register circuit to output the forward gate signals for scanning the gate lines so as to drive the rows of pixel units based on a sequence along the first direction when the scanning mode is a first scanning mode; and enabling the second shift register circuit to output the backward gate signals for scanning the gate lines so as to drive the rows of pixel units based on a sequence along the second direction when the scanning mode is a second scanning mode.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram showing a prior-art liquid crystal display.

FIGS. 2A and 2B are schematic diagrams showing display devices in accordance with a first embodiment of the present invention.

FIG. 3 is a schematic diagram showing a display device in accordance with a second embodiment of the present invention.

FIG. 4 is a schematic diagram showing a display device in accordance with a third embodiment of the present invention.

FIG. 5 is a schematic diagram showing a display device in accordance with a fourth embodiment of the present invention.

FIG. 6 is a schematic diagram showing a display device in accordance with a fifth embodiment of the present invention.

FIG. 7 is a schematic diagram showing a display device in accordance with a sixth embodiment of the present invention.

FIG. 8 is a flowchart depicting a gate signal scanning method according to the present invention.

FIG. 9 is a flowchart depicting another gate signal scanning method according to the present invention.

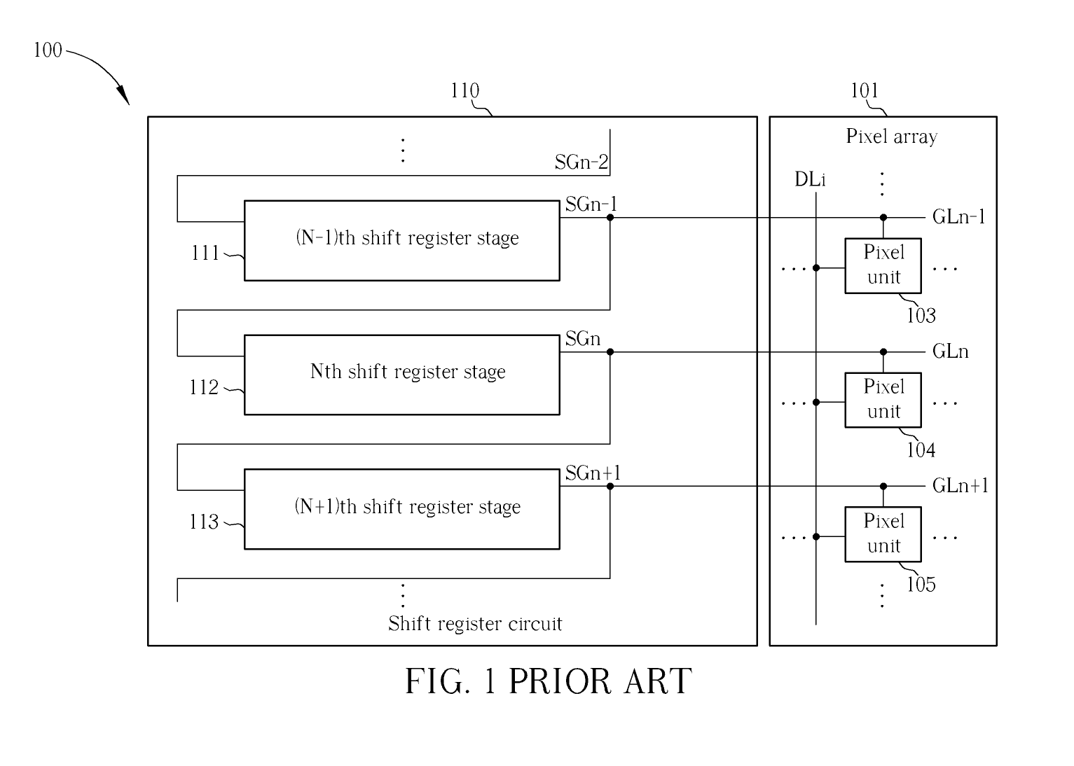

### DETAILED DESCRIPTION

Hereinafter, preferred embodiments of the present invention will be described in detail with reference to the accompanying drawings. Here, it is to be noted that the present invention is not limited thereto. Furthermore, the step serial numbers regarding the gate signal scanning method are not meant thereto limit the operating sequence, and any rearrangement of the operating sequence for achieving same functionality is still within the spirit and scope of the invention.

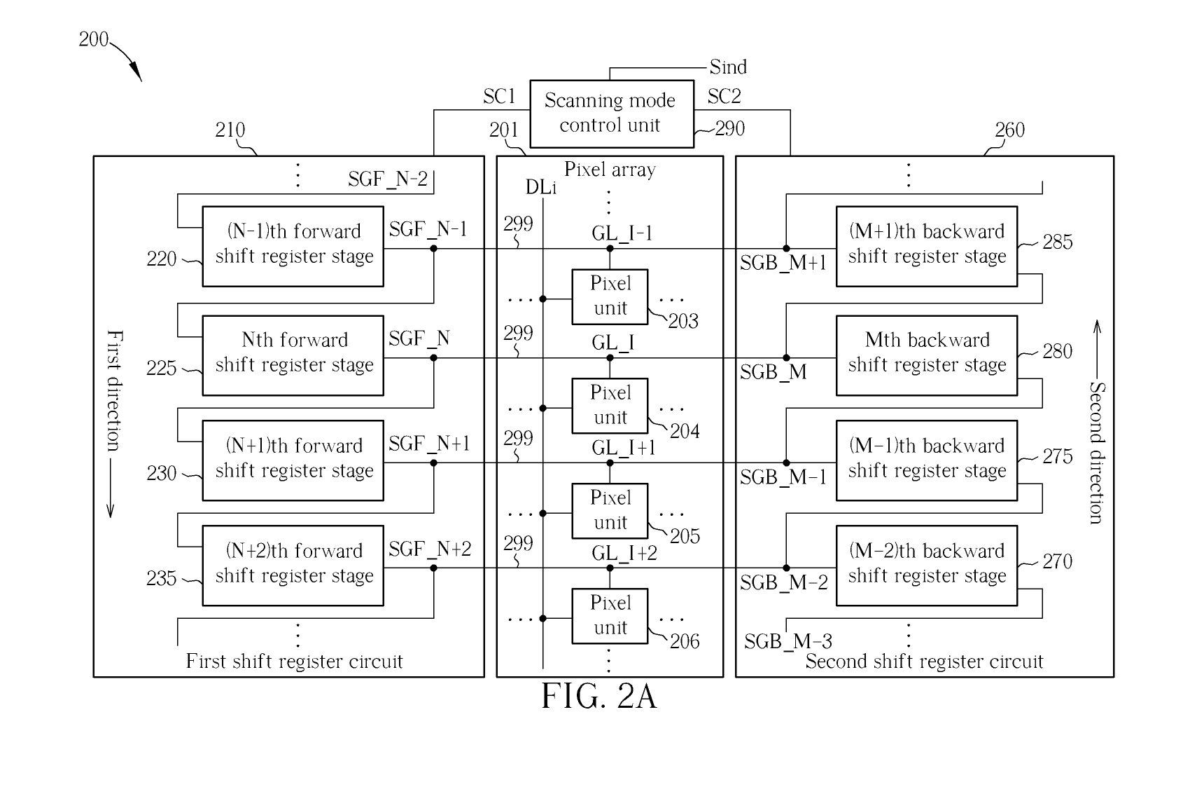

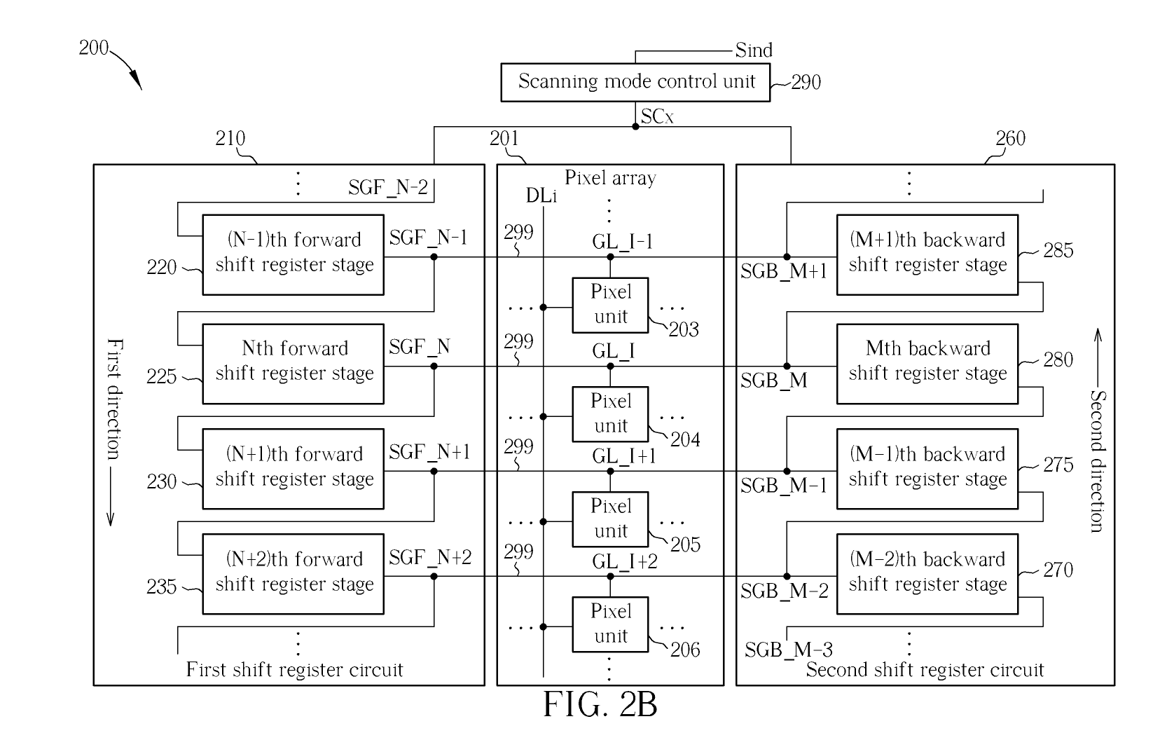

FIG. 2A is a schematic diagram showing a display device in accordance with a first embodiment of the present invention. As shown in FIG. 2A, the display device 200 comprises a pixel array 201, a first shift register circuit 210, a second shift register circuit 260, and a scanning mode control unit 290. The pixel array 201 includes plural rows of pixel units and plural parallel gate lines 299. The rows of pixel units and the gate lines 299 are sequentially disposed along a first direction and, for the sake of brevity, illustrate only the pixel unit 203 of an (I−1)th row, the pixel unit 204 of an Ith row, the pixel unit 205 of an (I+1)th row, the pixel unit 206 of an (I+2)th row, and four gate lines GL_I−1˜GL_I+2. The first shift register circuit 210 comprises a plurality of forward shift register stages disposed sequentially along the first direction. The second shift register circuit 260 comprises a plurality of backward shift register stages disposed sequentially along a second direction opposite to the first direction. For ease of explanation, the first shift register circuit 210 illustrates an (N−1)th forward shift register stage 220, an Nth forward shift register stage 225, an (N+1)th forward shift register stage 230, and an (N+2)th forward shift register stage 235. Also, the second shift register circuit 260 illustrates an (M−2)th backward shift register stage 270, an (M−1)th backward shift register stage 275, an Mth backward shift register stage 280, and an (M+1)th backward shift register stage 285. The numbers N, M and I are positive integers.

The scanning mode control unit 290, electrically connected to the first shift register circuit 210 and the second shift register circuit 260, functions to provide a first control signal SC1 and a second control signal SC2 according to an indication signal Sind. The first control signal SC1 is employed to enable the first shift register circuit 210 and the second control signal SC2 is employed to enable the second shift register circuit 260. In another embodiment as shown in FIG. 2B, the scanning mode control unit 290 may function to provide a single control signal SCx for enabling either the first shift register circuit 210 or the second shift register circuit 260 at any moment. For instance, the control signal SCx having high voltage level is employed to enable the first shift register circuit 210 and the control signal SCx having low voltage level is employed to enable the second shift register circuit 260. That is, the first control signal SC1 and the second control signal SC2 can be the same control signal. Both the (N−1)th forward shift register stage 220 and the (M+1)th backward shift register stage 285 are electrically connected to the pixel unit 203 via the gate line GL_I−1. Both the Nth forward shift register stage 225 and the Mth backward shift register stage 280 are electrically connected to the pixel unit 204 via the gate line GLI. Both the (N+1)th forward shift register stage 230 and the (M−1)th backward shift register stage 275 are electrically connected to the pixel unit 205 via the gate line GL_I+1. Both the (N+2)th forward shift register stage 235 and the (M−2)th backward shift register stage 270 are electrically connected to the pixel unit 206 via the gate line GL_I+2.

The (N−1)th forward shift register stage 220 is enabled to generate a forward gate signal SGF_N−1 based on a forward gate signal SGF_N−2 generated by a preceding forward shift register stage, i.e. the forward gate signal SGF_N−2 is also functioning as a start pulse signal for enabling the (N−1)th forward shift register stage 220. The forward gate signal SGF_N−1 is furnished to the pixel unit 203 via the gate line GL_I−1 for providing a control of writing a corresponding data signal of the data line DLi into the pixel unit 203. The forward gate signal SGF_N−1 is further furnished to the Nth forward shift register stage 225 and functions as a start pulse signal for enabling the Nth forward shift register stage 225 to generate a forward gate signal SGF_N. Similarly, the forward gate signal SGF_N is used for providing a writing control of the pixel unit 204 and for enabling the (N+1)th forward shift register stage 230 to generate a forward gate signal SGF_N+1. Also, the forward gate signal SGF_N+1 is used for providing a writing control of the pixel unit 205 and for enabling the (N+2)th forward shift register stage 235 to generate a forward gate signal SGF_N+2, which in turn provides a writing control of the pixel unit 206. In other words, the first shift register circuit 210 is employed to provide plural forward gate signals sequentially enabled for scanning the gate lines 299 along the first direction. Accordingly, the forward gate signals are put in use for driving the rows of pixel units in the pixel array 201 based on a sequence along the first direction.

The (M−2)th backward shift register stage 270 is enabled to generate a backward gate signal SGB_M−2 based on a backward gate signal SGB_M−3 generated by a preceding backward shift register stage. The backward gate signal SGB_M−2 is used for providing a writing control of the pixel unit 206 via the gate line GL_I+2 and for enabling the (M−1)th backward shift register stage 275 to generate a backward gate signal SGB_M−1. Similarly, the backward gate signal SGB_M−1 is used for providing a writing control of the pixel unit 205 and for enabling the Mth backward shift register stage 280 to generate a backward gate signal SGB_M. Also, the backward gate signal SGB_M is used for providing a writing control of the pixel unit 204 and for enabling the (M+1)th backward shift register stage 285 to generate a backward gate signal SGB_M+1, which in turn provides a writing control of the pixel unit 203. In other words, the second shift register circuit 260 is employed to provide plural backward gate signals sequentially enabled for scanning the gate lines 299 along the second direction. Accordingly, the backward gate signals are put in use for driving the rows of pixel units in the pixel array 201 based on a sequence along the second direction.

In summary, the display device 200 makes use of the indication signal Sind to set different scanning directions according to different embedding installations regarding various electronic products. Consequently, the display device 200 is able to provide a high-compatible display scanning standard for existing diversified electronic products to accommodate, i.e. for achieving high embedding flexibility.

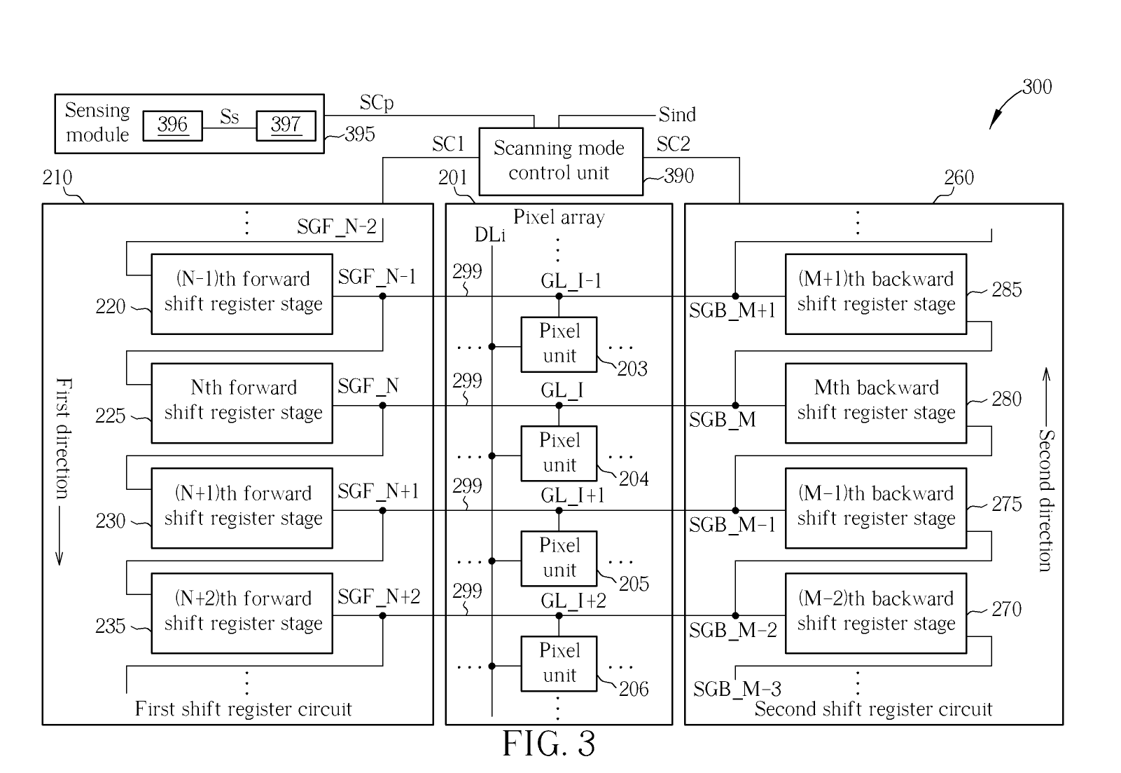

As shown in FIG. 3, the display device 300 is similar to the display device 200 shown in FIG. 2A, differing in that a sensing module 395 is further added and the scanning mode control unit 290 is replaced with a scanning mode control unit 390. The sensing module 395 comprises a pose sensor 396 and a signal processing unit 397. The pose sensor 396 can be a gravity sensing device or an orientation sensor. The pose sensor 396 is employed to sense the pose status of the display device 300 for generating a sensing signal Ss. The signal processing unit 397, electrically connected to the pose sensor 396, functions to perform a signal operation on the sensing signal Ss for generating a preliminary control signal SCp. The scanning mode control unit 390, electrically connected to the sensing module 395, the first shift register circuit 210 and the second shift register circuit 260, is operative to generate the first control signal SC1 and the second control signal SC2 according to the indication signal Sind and/or the preliminary control signal SCp. And as aforementioned, the first control signal SC1 and the second control signal SC2 are employed to enable either the first shift register circuit 210 or the second shift register circuit 260 for scanning the gate lines 299. That is, the display device 300 is able to set a desirable scanning mode for displaying images according to the indication signal Sind.

When the display device 300 enters a first scanning mode according to the indication signal Sind, the scanning mode control unit 390 outputs the first control signal SC1 for enabling the first shift register circuit 210 so as to scan the gate lines 299 sequentially along the first direction. When the display device 300 enters a second scanning mode according to the indication signal Sind, the scanning mode control unit 390 outputs the second control signal SC2 for enabling the second shift register circuit 260 so as to scan the gate lines 299 sequentially along the second direction. When the display device 300 enters a sense-setting scanning mode according to the indication signal Sind, if the sensing module 395 detects a first pose status of the display device 300, the preliminary control signal SCp is utilized for driving the scanning mode control unit 390 to output the first control signal SC1 for enabling the first shift register circuit 210 so as to scan the gate lines 299 sequentially along the first direction. Alternatively, if the sensing module 395 detects a second pose status of the display device 300, the preliminary control signal SCp is utilized for driving the scanning mode control unit 390 to output the second control signal SC2 for enabling the second shift register circuit 260 so as to scan the gate lines 299 sequentially along the second direction. In comparison with the prior-art display device, it is obvious that the application of the display device 300 is more flexible and convenient.

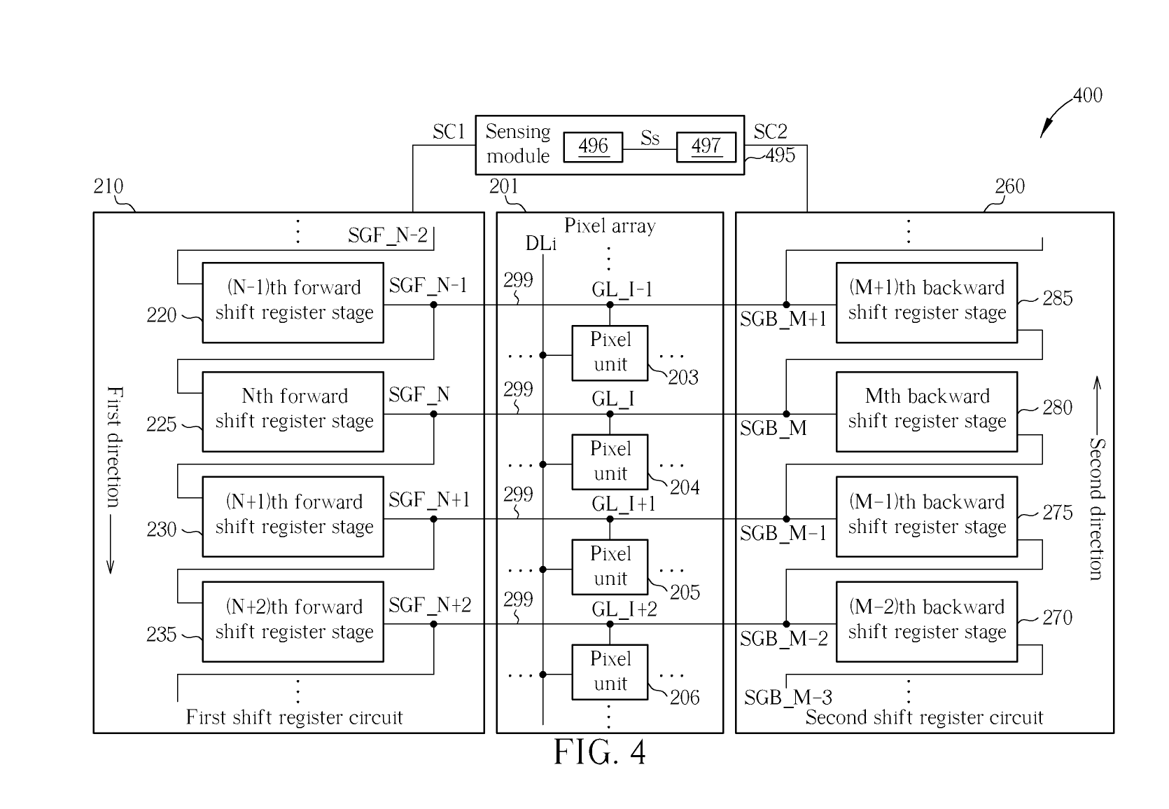

FIG. 4 is a schematic diagram showing a display device in accordance with a third embodiment of the present invention. As shown in FIG. 4, the display device 400 is similar to the display device 200 shown in FIG. 2A, differing only in that the scanning mode control unit 290 is replaced with a sensing module 495. The sensing module 495 comprises a pose sensor 496 and a signal processing unit 497. The pose sensor 496 can be a gravity sensing device or an orientation sensor. The pose sensor 496 is employed to sense the pose status of the display device 400 for generating a sensing signal Ss. The signal processing unit 497, electrically connected to the pose sensor 496, functions to perform a signal operation on the sensing signal Ss for generating a first control signal SC1 and a second control signal SC2. Still, as aforementioned, the first control signal SC1 and the second control signal SC2 are employed to enable either the first shift register circuit 210 or the second shift register circuit 260 for scanning the gate lines 299. In other words, the display device 400 is capable of automatically setting a scanning mode for displaying images based on the pose status thereof and its application is therefore more flexible and convenient.

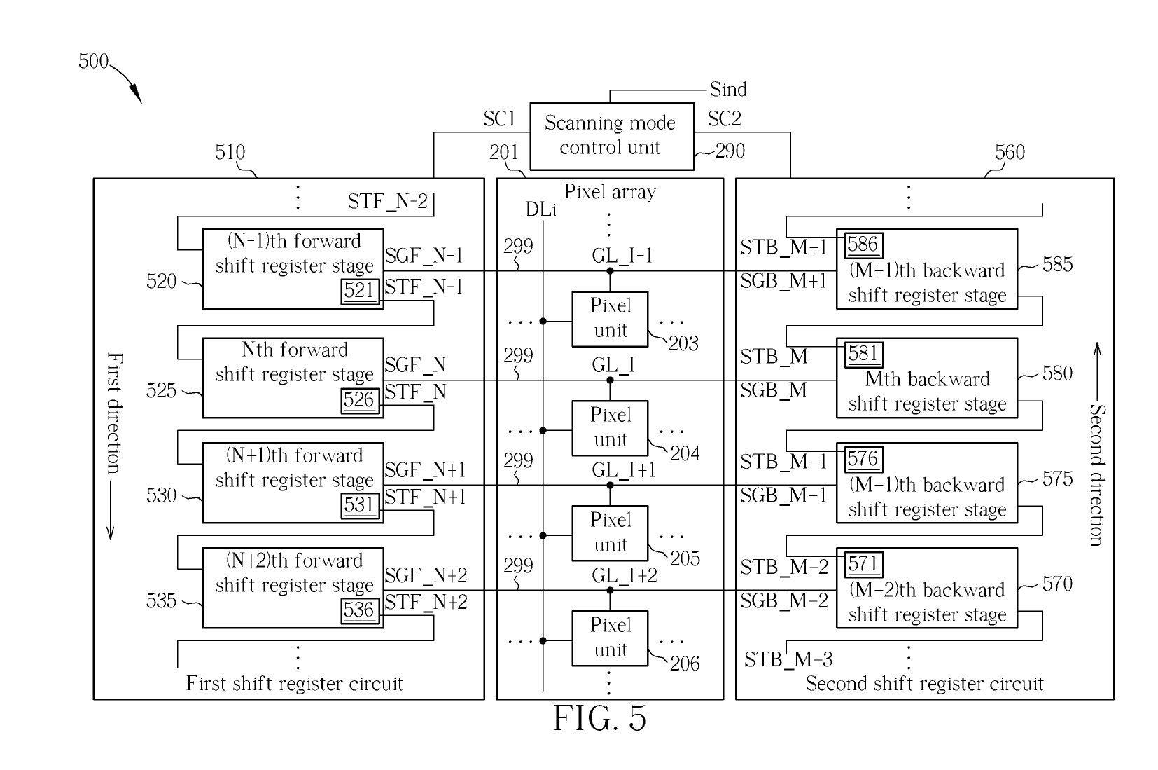

FIG. 5 is a schematic diagram showing a display device in accordance with a fourth embodiment of the present invention. As shown in FIG. 5, the display device 500 comprises the pixel array 201, a first shift register circuit 510, a second shift register circuit 560, and the scanning mode control unit 290. The first shift register circuit 510 comprises a plurality of forward shift register stages disposed sequentially along the first direction. The second shift register circuit 560 comprises a plurality of backward shift register stages disposed sequentially along the second direction. For ease of explanation, the first shift register circuit 510 illustrates an (N−1)th forward shift register stage 520, an Nth forward shift register stage 525, an (N+1)th forward shift register stage 530, and an (N+2)th forward shift register stage 535. Also, the second shift register circuit 560 illustrates an (M−2)th backward shift register stage 570, an (M−1)th backward shift register stage 575, an Mth backward shift register stage 580, and an (M+1)th backward shift register stage 585. The first shift register circuit 510 and the second shift register circuit 560 are respectively similar to the first shift register circuit 210 and the second shift register circuit 260 shown in FIG. 2A. Compared with the first shift register circuit 210, each forward shift register stage of the first shift register circuit 510 further comprises a forward carry unit for providing a corresponding forward start pulse signal. Compared with the second shift register circuit 260, each backward shift register stage of the second shift register circuit 560 further comprises a backward carry unit for providing a corresponding backward start pulse signal.

For instance, the (N−1)th forward shift register stage 520 further comprises a forward carry unit 521 for providing a forward start pulse signal STFN−1, the (N+2)th forward shift register stage 535 further comprises a forward carry unit 536 for providing a forward start pulse signal STF_N+2, the (M−2)th backward shift register stage 570 further comprises a backward carry unit 571 for providing a backward start pulse signal STB_N−2, the (M+1)th backward shift register stage 585 further comprises a backward carry unit 586 for providing a backward start pulse signal STB_M+1, and the other forward and backward shift register stages can be inferred by analogy. In view of that, regarding the operation of the first shift register circuit 510, each forward shift register stage is enabled to generate both a corresponding forward gate signal and a corresponding forward start pulse signal based on one forward start pulse signal provided by a preceding forward shift register stage. For instance, the Nth forward shift register stage 525 is enabled to generate both the forward gate signal SGF_N and the forward start pulse signal STFN based on the forward start pulse signal STF_N−1. Similarly, regarding the operation of the second shift register circuit 560, each backward shift register stage is enabled to generate both a corresponding backward gate signal and a corresponding backward start pulse signal based on one backward start pulse signal provided by a preceding backward shift register stage. For instance, the Mth backward shift register stage 580 is enabled to generate both the backward gate signal SGB_M and the backward start pulse signal STB_M based on the backward start pulse signal STB_M−1. The other circuit operation of the display device 500 is substantially identical to that of the display device 200 shown in FIG. 2A, and for the sake of brevity, further similar discussion thereof is omitted.

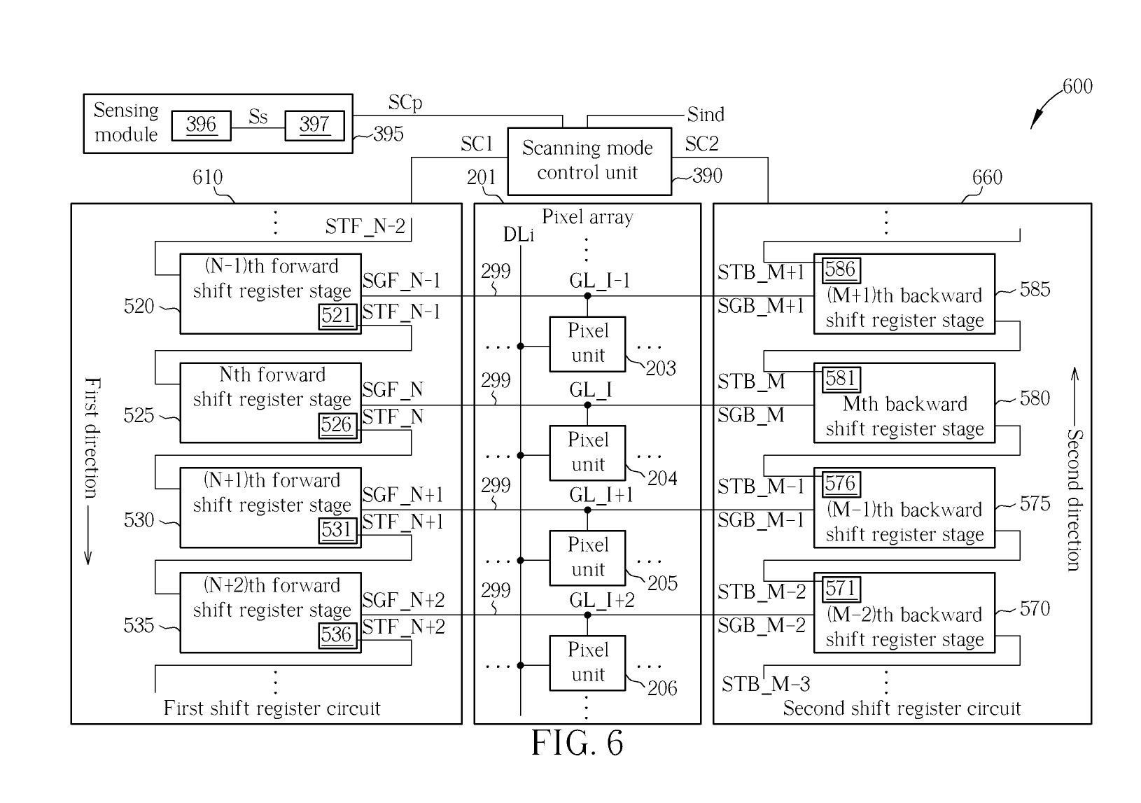

FIG. 6 is a schematic diagram showing a display device in accordance with a fifth embodiment of the present invention. As shown in FIG. 6, the display device 600 is similar to the display device 300 shown in FIG. 3, differing in that the first shift register circuit 210 is replaced with a first shift register circuit 610 and the second shift register circuit 260 is replaced with a second shift register circuit 660. The internal structures and circuit operations of the first shift register circuit 610 and the second shift register circuit 660 are identical respectively to the internal structures and circuit operations of the first shift register circuit 510 and the second shift register circuit 560 shown in FIG. 5. Except for the internal circuit operations of the first shift register circuit 610 and the second shift register circuit 660, the other circuit operation of the display device 600 is substantially identically to that of the display device 300, and for the sake of brevity, further similar discussion thereof is omitted.

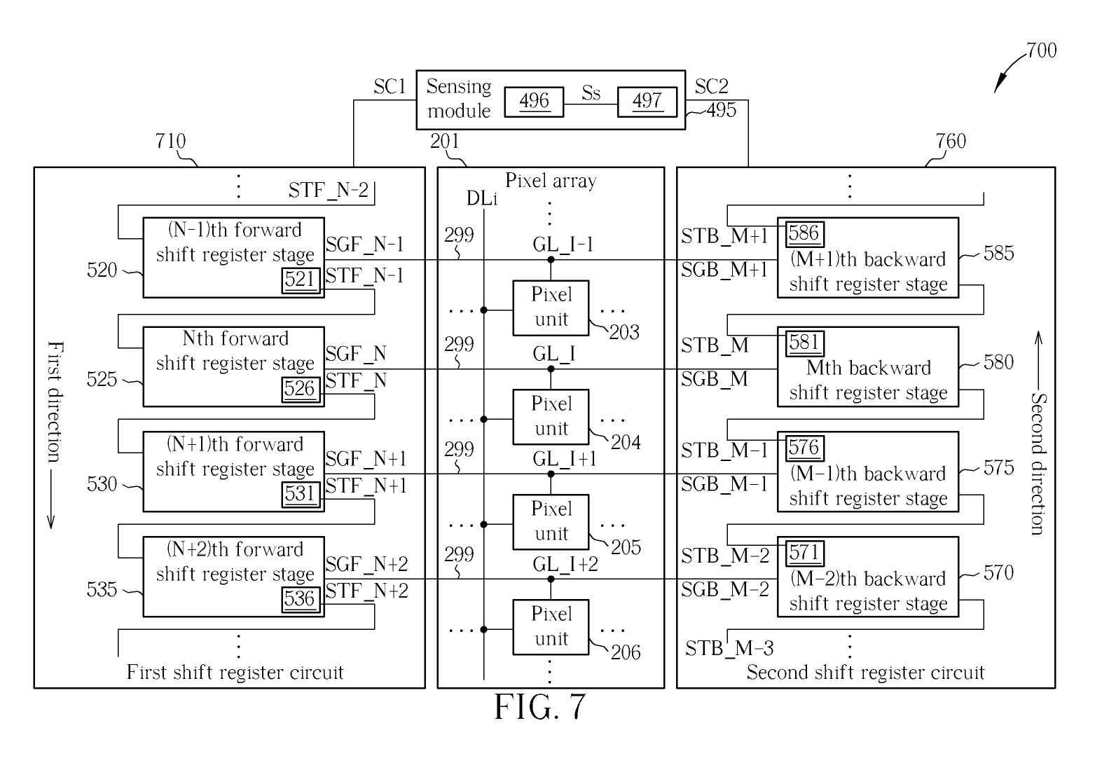

FIG. 7 is a schematic diagram showing a display device in accordance with a sixth embodiment of the present invention. As shown in FIG. 7, the display device 700 is similar to the display device 400 shown in FIG. 4, differing in that the first shift register circuit 210 is replaced with a first shift register circuit 710 and the second shift register circuit 260 is replaced with a second shift register circuit 760. The internal structures and circuit operations of the first shift register circuit 710 and the second shift register circuit 760 are respectively identical to the internal structures and circuit operations of the first shift register circuit 510 and the second shift register circuit 560 shown in FIG. 5. Except for the internal circuit operations of the first shift register circuit 710 and the second shift register circuit 760, the other circuit operation of the display device 700 is substantially identically to that of the display device 400, and for the sake of brevity, further similar discussion thereof is omitted.

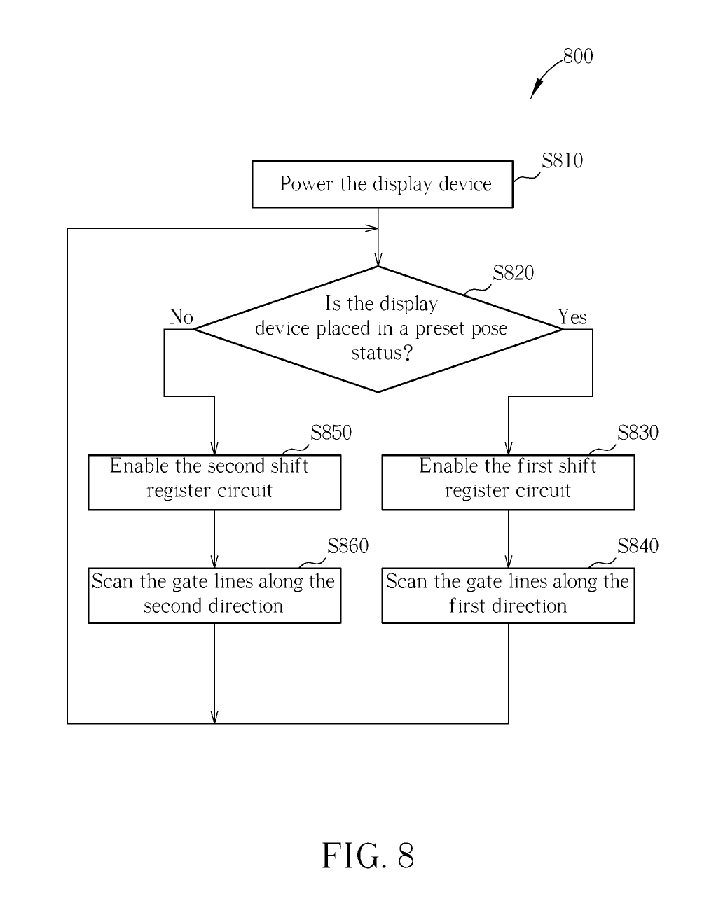

FIG. 8 is a flowchart depicting a gate signal scanning method according to the present invention. The gate signal scanning method regarding the flow 800 shown in FIG. 8 is implemented based on the display device 400 shown in FIG. 4. The gate signal scanning method illustrated in the flow 800 comprises the following steps:

Step S810: Power the display device 400.

Step S820: The sensing module 495 detects whether the display device 400 is placed in a preset pose status. If the pose status of the display device 400 is detected to be the preset pose status, go to step S830. Otherwise, go to step S850.

Step S830: The sensing module 495 outputs the first control signal SC1 for enabling the first shift register circuit 210.

Step S840: The first shift register circuit 210 provides the forward gate signals sequentially enabled for scanning the gate lines 299 along the first direction so as to drive the rows of pixel units in the pixel array 201 based on a sequence along the first direction. Go to step S820.

Step S850: The sensing module 495 outputs the second control signal SC2 for enabling the second shift register circuit 260.

Step S860: The second shift register circuit 260 provides the backward gate signals sequentially enabled for scanning the gate lines 299 along the second direction so as to drive the rows of pixel units in the pixel array 201 based on a sequence along the second direction. Go to step S820.

In the flow 800 of the gate signal scanning method, the preset pose status is equivalent to the aforementioned first pose status. Consequently, the steps S850 and S860 are employed to perform related scanning processes when the display device 400 is placed in the aforementioned second pose status. In another embodiment, the first control signal SC1 and the second control signal SC2 can be replaced with the single control signal SCx illustrated in FIG. 2B for enabling either first shift register circuit 210 or the second shift register circuit 260 at any moment. For instance, the control signal SCx having high voltage level is employed to enable the first shift register circuit 210 and the control signal SCx having low voltage level is employed to enable the second shift register circuit 260. Besides, in another embodiment, if the display device 400, the first shift register circuit 210 and the second shift register circuit 260 are respectively replaced with the display device 700, the first shift register circuit 710 and the second shift register circuit 760, the gate signal scanning method disclosed in the flow 800 can be applied to the display device 700 shown in FIG. 7.

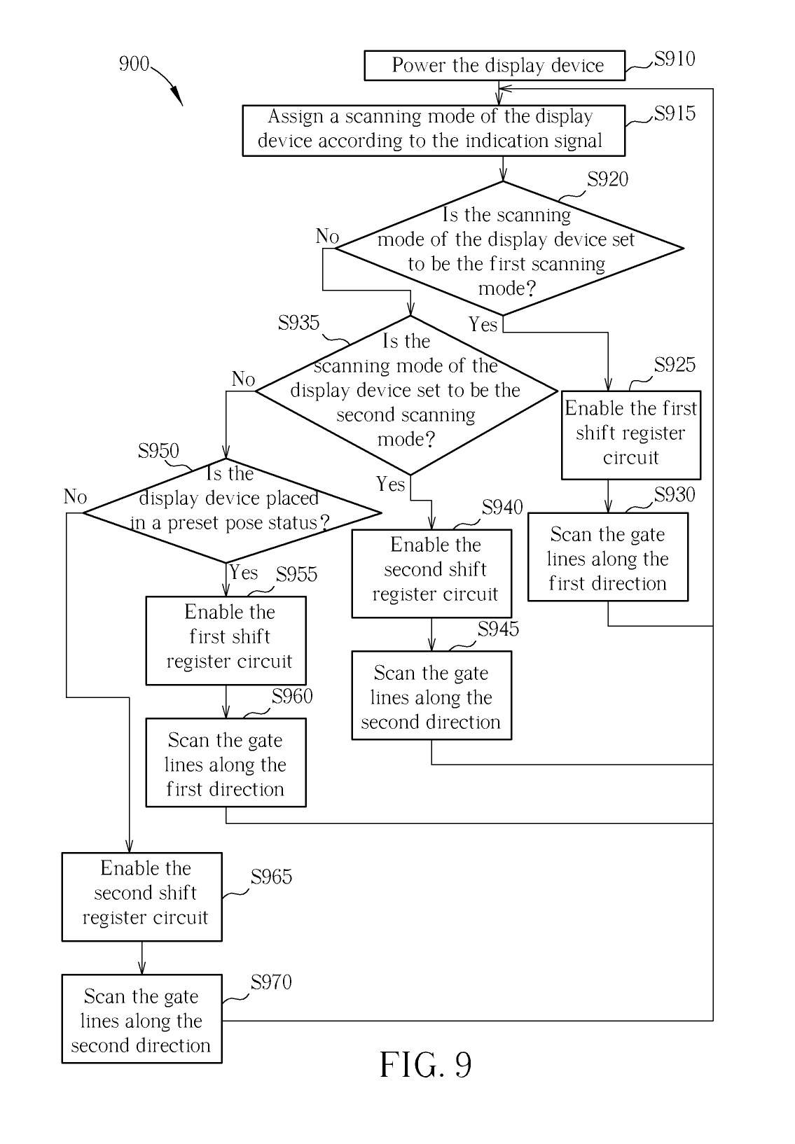

FIG. 9 is a flowchart depicting another gate signal scanning method according to the present invention. The gate signal scanning method regarding the flow 900 shown in FIG. 9 is implemented based on the display device 300 shown in FIG. 3. The gate signal scanning method illustrated in the flow 900 comprises the following steps:

Step S910: Power the display device 300.

Step S915: The scanning mode control unit 390 assigns a scanning mode of the display device 300 according to the indication signal Sind.

Step S920: Determine whether the scanning mode of the display device 300 is set to be the first scanning mode. If the scanning mode of the display device 300 is set to be the first scanning mode, go to step S925. Otherwise, go to step S935.

Step S925: The scanning mode control unit 390 outputs the first control signal SC1 for enabling the first shift register circuit 210.

Step S930: The first shift register circuit 210 provides the forward gate signals sequentially enabled for scanning the gate lines 299 along the first direction so as to drive the rows of pixel units in the pixel array 201 based on a sequence along the first direction. Go to step S915.

Step S935: Determine whether the scanning mode of the display device 300 is set to be the second scanning mode. If the scanning mode of the display device 300 is set to be the second scanning mode, go to step S940. Otherwise, go to step S950.

Step S940: The scanning mode control unit 390 outputs the second control signal SC2 for enabling the second shift register circuit 260.

Step S945: The second shift register circuit 260 provides the backward gate signals sequentially enabled for scanning the gate lines 299 along the second direction so as to drive the rows of pixel units in the pixel array 201 based on a sequence along the second direction. Go to step S915.

Step S950: The sensing module 395 detects whether the display device 300 is placed in a preset pose status. If the pose status of the display device 300 is detected to be the preset pose status, go to step S955. Otherwise, go to step S965.

Step S955: The sensing module 395 provides the preliminary control signal SCp for driving the scanning mode control unit 390 to output the first control signal SC1 for enabling the first shift register circuit 210.

Step S960: The first shift register circuit 210 provides the forward gate signals sequentially enabled for scanning the gate lines 299 along the first direction so as to drive the rows of pixel units in the pixel array 201 based on a sequence along the first direction. Go to step S915.

Step S965: The sensing module 395 provides the preliminary control signal SCp for driving the scanning mode control unit 390 to output the second control signal SC2 for enabling the second shift register circuit 260.

Step S970: The second shift register circuit 260 provides the backward gate signals sequentially enabled for scanning the gate lines 299 along the second direction so as to drive the rows of pixel units in the pixel array 201 based on a sequence along the second direction. Go to step S915.

In the flow 900 of the gate signal scanning method, the steps S950-S970 are employed to perform related scanning processes after the display device 300 enters the aforementioned sense-setting scanning mode. The preset pose status is equivalent to the aforementioned first pose status, and therefore the steps S965 and S970 are employed to perform related scanning processes when the display device 300 is placed in the aforementioned second pose status.

In another embodiment, the first control signal SC1 and the second control signal SC2 can be replaced with the single control signal SCx illustrated in FIG. 2B for enabling either first shift register circuit 210 or the second shift register circuit 260 at any moment. For instance, the control signal SCx having high voltage level is employed to enable the first shift register circuit 210 and the control signal SCx having low voltage level is employed to enable the second shift register circuit 260.

Besides, in another embodiment, if the display device 300, the first shift register circuit 210 and the second shift register circuit 260 are respectively replaced with the display device 600, the first shift register circuit 610 and the second shift register circuit 660, the gate signal scanning method disclosed in the flow 900 can be applied to the display device 600 shown in FIG. 6. Alternatively, if the display device 300 and the scanning mode control unit 390 are respectively replaced with the display device 200 and the scanning mode control unit 290 and the steps S950-S970 are omitted, the gate signal scanning method disclosed in the flow 900 can be applied to the display device 200 shown in FIG. 2A. Likewise, if the display device 300, the scanning mode control unit 390, the first shift register circuit 210 and the second shift register circuit 260 are respectively replaced with the display device 500, the scanning mode control unit 290, the first shift register circuit 510 and the second shift register circuit 560 and the steps S950-S970 are omitted, the gate signal scanning method disclosed in the flow 900 can be applied to the display device 500 shown in FIG. 5.

In conclusion, the display device of the present invention is capable of setting different scanning directions according to different embedding installations regarding various electronic products so as to provide a high-compatible display scanning standard for existing diversified electronic products to accommodate, i.e. for achieving high embedding flexibility. Besides, the gate signal scanning method of the present invention is capable of setting a desirable scanning mode according to the pose status of display device, and the application thereof is then more flexible and convenient.

The present invention is by no means limited to the embodiments as described above by referring to the accompanying drawings, which may be modified and altered in a variety of different ways without departing from the scope of the present invention. Thus, it should be understood by those skilled in the art that various modifications, combinations, sub-combinations and alternations might occur depending on design requirements and other factors insofar as they are within the scope of the appended claims or the equivalents thereof.

What is claimed is:

1. A display device comprising:
a pixel array having a plurality of rows of pixel units and a plurality of parallel gate lines, the gate lines being perpendicular to a first direction and disposed sequentially along the first direction, wherein each of the gate lines is electrically connected to plural pixel units in a corresponding row of pixel units;
a first shift register circuit having a plurality of forward shift register stages, the forward shift register stages being employed to provide plural forward gate signals sequentially enabled for scanning the gate lines so as to drive the rows of pixel units base on a sequence along the first direction when the first shift register circuit is enabled; and
a second shift register circuit having a plurality of backward shift register stages, the backward shift register stages being employed to provide plural backward gate signals sequentially enabled for scanning the gate lines so as to drive the rows of pixel units base on a sequence along a second direction opposite to the first direction when the second shift register circuit is enabled;
wherein each of the gate lines is further electrically connected to both a corresponding forward shift register stage of the first shift register circuit and a corresponding backward shift register stage of the second shift register circuit.

2. The display device of claim 1, wherein:
the pixel array comprises an (I−1)th row of pixel units, an Ith row of pixel units, an (I+1)th row of pixel units, an (I−1)th gate line, an Ith gate line, and an (I+1)th gate line, the (I−1) th gate line being electrically connected to plural pixel units in the (I−1)th row of pixel units, the Ith gate line being electrically connected to plural pixel units in the Ith row of pixel units, the (I+1)th gate line being electrically connected to plural pixel units in the (I+1)th row of pixel units.

3. The display device of claim 2, wherein the first shift register circuit comprises:
an (N−1)th forward shift register stage, electrically connected to the (I−1)th gate line, for providing an (N−1)th forward gate signal furnished to the (I−1)th gate line;
an Nth forward shift register stage, electrically connected to the Ith gate line and the (N−1)th forward shift register stage, for providing an Nth forward gate signal furnished to the Ith gate line according to the (N−1)th forward gate signal; and
an (N+1)th forward shift register stage, electrically connected to the (I+1)th gate line and the Nth forward shift register stage, for providing an (N+1)th forward gate signal furnished to the (I+1)th gate line according to the Nth forward gate signal.

4. The display device of claim 2, wherein the first shift register circuit comprises:
an (N−1)th forward shift register stage, electrically connected to the (I−1)th gate line, for providing an (N−1)th forward gate signal and an (N−1)th forward start pulse signal, the (N−1)th forward gate signal being furnished to the (I−1)th gate line;
an Nth forward shift register stage, electrically connected to the Ith gate line and the (N−1)th forward shift register stage, for providing an Nth forward gate signal and an Nth forward start pulse signal according to the (N−1)th forward start pulse signal, the Nth forward gate signal being furnished to the Ith gate line; and
an (N+1)th forward shift register stage, electrically connected to the (I+1)th gate line and the Nth forward shift register stage, for providing an (N+1)th forward gate signal furnished to the (I+1)th gate line according to the Nth forward start pulse signal.

5. The display device of claim 4, wherein:
the (N−1)th forward shift register stage comprises an (N−1)th forward carry unit electrically connected to the Nth forward shift register stage, the (N−1)th forward carry unit being employed to provide the (N−1)th forward start pulse signal; and
the Nth forward shift register stage comprises an Nth forward carry unit electrically connected to the (N+1)th forward shift register stage, the Nth forward carry unit being employed to provide the Nth forward start pulse signal.

6. The display device of claim 2, wherein the second shift register circuit comprises:
an (M−1)th backward shift register stage, electrically connected to the (I+1)th gate line, for providing an (M−1)th backward gate signal furnished to the (I+1)th gate line;
an Mth backward shift register stage, electrically connected to the Ith gate line and the (M−1)th backward shift register stage, for providing an Mth backward gate signal furnished to the Ith gate line according to the (M−1) th backward gate signal; and
an (M+1)th backward shift register stage, electrically connected to the (I−1)th gate line and the Mth backward shift register stage, for providing an (M+1)th backward gate signal furnished to the (I−1)th gate line according to the Mth backward gate signal.

7. The display device of claim 2, wherein the second shift register circuit comprises:
an (M−1)th backward shift register stage, electrically connected to the (I+1)th gate line, for providing an (M−1)th backward gate signal and an (M−1)th backward start pulse signal, the (M−1) th backward gate signal being furnished to the (I+1)th gate line;
an Mth backward shift register stage, electrically connected to the Ith gate line and the (M−1)th backward shift register stage, for providing an Mth backward gate signal and an Mth backward start pulse signal according to the (M−1)th backward start pulse signal, the Mth backward gate signal being furnished to the Ith gate line; and
an (M+1)th backward shift register stage, electrically connected to the (I−1)th gate line and the Mth backward shift register stage, for providing an (M+1)th backward gate signal furnished to the (I−1)th gate line according to the Mth backward start pulse signal.

8. The display device of claim 7, wherein:
the (M−1)th backward shift register stage comprises an (M−1)th backward carry unit electrically connected to the Mth backward shift register stage, the (M−1)th backward carry unit being employed to provide the (M−1)th backward start pulse signal; and
the Mth backward shift register stage comprises an Mth backward carry unit electrically connected to the (M+1)th backward shift register stage, the Mth backward carry unit being employed to provide the Mth backward start pulse signal.

9. The display device of claim 1, further comprising:
a scanning mode control unit, electrically connected to the first shift register circuit and the second shift register circuit, for enabling either the first shift register circuit or the second shift register circuit according to an indication signal.

10. The display device of claim 1, further comprising:
a sensing module comprising:
a pose sensor for detecting a pose status of the display device so as to generate a sensing signal; and
a signal processing unit, electrically connected to the pose sensor, for performing a signal operation on the sensing signal so as to generate a preliminary control signal; and
a scanning mode control unit, electrically connected to the sensing module, the first shift register circuit and the second shift register circuit, for generating at least one control signal according to the preliminary control signal or an indication signal, the at least one control signal being employed to enable either the first shift register circuit or the second shift register circuit.

11. The display device of claim 10, wherein the pose sensor is a gravity sensing device or an orientation sensor.

12. The display device of claim 1, further comprising:
a sensing module, electrically connected to the first shift register circuit and the second shift register circuit, for detecting a pose status of the display device so as to enable either the first shift register circuit or the second shift register circuit.

13. The display device of claim 12, wherein the sensing module comprises:
a pose sensor for detecting the pose status of the display device so as to generate a sensing signal; and
a signal processing unit, electrically connected to the pose sensor, for performing a signal operation on the sensing signal so as to generate at least one control signal, the at least one control signal being employed to enable either the first shift register circuit or the second shift register circuit.

14. The display device of claim 13, wherein the pose sensor is a gravity sensing device or an orientation sensor.

15. A gate signal scanning method comprising:
providing a display device, the display device comprising:
a pixel array having a plurality of rows of pixel units and a plurality of gate lines, the gate lines being perpendicular to a first direction and disposed sequentially along the first direction, wherein each of the gate lines is electrically connected to plural pixel units in a corresponding row of pixel units;
a first shift register circuit for providing plural forward gate signals sequentially enabled for scanning the gate lines base on a sequence along the first direction; and
a second shift register circuit for providing plural backward gate signals sequentially enabled for scanning the gate lines base on a sequence along a second direction opposite to the first direction;
powering the display device;
detecting a pose status of the display device;
enabling the first shift register circuit to output the forward gate signals for scanning the gate lines so as to drive the rows of pixel units based on a sequence along the first direction when the pose status of the display device is detected to be a first pose status; and
enabling the second shift register circuit to output the backward gate signals for scanning the gate lines so as to drive the rows of pixel units based on a sequence along the second direction when the pose status of the display device is detected to be a second pose status.

16. A gate signal scanning method comprising:
providing a display device, the display device comprising:
a pixel array having a plurality of rows of pixel units and a plurality of gate lines, the gate lines being perpendicular to a first direction and disposed sequentially along the first direction, wherein each of the gate lines is electrically connected to plural pixel units in a corresponding row of pixel units;
a first shift register circuit for providing plural forward gate signals sequentially enabled for scanning the gate lines base on a sequence along the first direction; and
a second shift register circuit for providing plural backward gate signals sequentially enabled for scanning the gate lines base on a sequence along a second direction opposite to the first direction;
powering the display device;
setting a scanning mode of the display device according to an indication signal;
enabling the first shift register circuit to output the forward gate signals for scanning the gate lines so as to drive the rows of pixel units based on a sequence along the first direction when the scanning mode is a first scanning mode; and
enabling the second shift register circuit to output the backward gate signals for scanning the gate lines so as to drive the rows of pixel units based on a sequence along the second direction when the scanning mode is a second scanning mode.

17. The gate signal scanning method of claim 16, further comprises:
detecting a pose status of the display device when the scanning mode is a sense-setting scanning mode;
enabling the first shift register circuit to output the forward gate signals for scanning the gate lines so as to drive the rows of pixel units based on a sequence along the first direction when the pose status of the display device is detected to be a first pose status; and
enabling the second shift register circuit to output the backward gate signals for scanning the gate lines so as to drive the rows of pixel units based on a sequence along the second direction when the pose status of the display device is detected to be a second pose status.
